(19) United States
(12) Patent Application Publication
(10) Pub. No.: US 2006/0095757 A1
(43) Pub. Date: May 4, 2006

(54) Firmware update method and system

(75) Inventor: Yen-Hui Chuang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/266,521

(22) Filed: Nov. 3, 2005

(30) Foreign Application Priority Data
Nov. 3, 2004 (TW) 93133470

(51) Int. Cl. G06F 1/24

(52) U.S. Cl. 713/100

(57) ABSTRACT

An update method for firmware in an optical storage device. Detection programs are sent to the optical storage device to acquire storage related information thereof. Update programs corresponding to the firmware are sent to the optical storage device according to the storage related information. Original firmware programs are sent to the optical storage device and updated by the update programs.

### BACKGROUND

The present invention relates to firmware update methods, and in particular to dynamic adjustment of updating update firmware programs.

With the technical progress of optical storage, firmware in hardware devices, such as disk drives or modems, requires updating by programs.

Conventionally, update programs for optical storage devices are generally stored in firmware, such as a flash read-only memory (flash ROM), with version corresponding to different update programs. Consequently, update programs are stored multiple versions, occupying considerable storage space. Furthermore, when firmware versions change, the firmware programs must be changed accordingly, limiting flexibility and increasing cost.

FIG. 1 is a flowchart of a conventional firmware update method. Original firmware programs are sent to an optical storage device (step S10). The optical storage device executes update programs to update the original firmware programs (step S12). Thereafter, the optical storage device may execute the updated firmware programs (step S14). As shown in FIG. 1, when the original firmware programs are updated, the update programs are first sent to the optical storage device. If more versions or types of firmware are added, the update programs are increased accordingly, and must be sent to the optical storage device as a whole even though only one type of firmware is updated, wasting resource.

Thus, dynamic update methods for multiple firmware versions or types and reduce storage requirements, are desirable.

### SUMMARY

Update methods for firmware in an optical storage device are provided. Detection programs are sent to the optical storage device to acquire storage related information. Update programs corresponding to the firmware are sent to the optical storage device according to the acquired storage related information. Original firmware programs are sent to the optical storage device and updated in the update programs.

### BRIEF DESCRIPTION OF THE DRAWINGS

Embodiments of the present invention can be more fully understood by reading the subsequent detailed description and examples with references made to the accompanying drawings, wherein:

FIG. 1 is a flowchart of a conventional firmware update method.

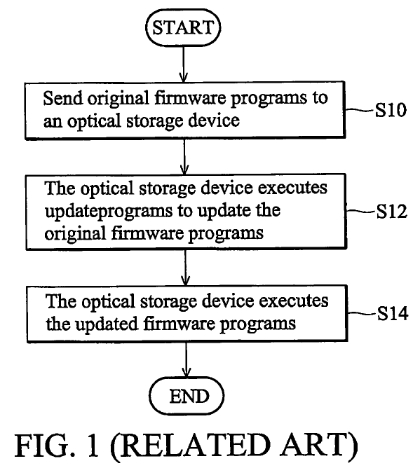

FIG. 2 is a flowchart of an embodiment of a firmware update method.

FIG. 3 is a diagram of an embodiment of a machine-readable storage medium storing a computer program providing a firmware update method.

FIG. 4 is a diagram of an embodiment of an optical storage device.

FIG. 5 is a diagram of an exemplary embodiment of an optical storage device.

### DETAILED DESCRIPTION

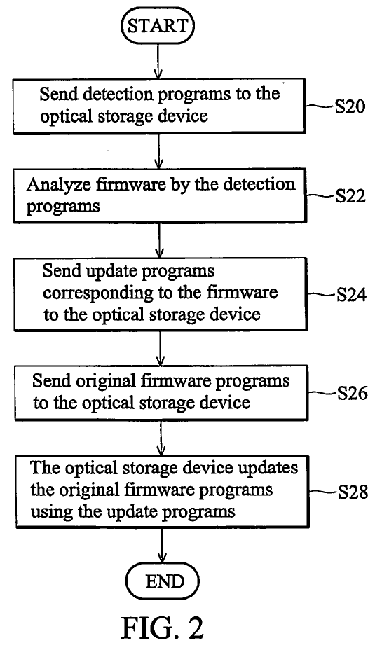

FIG. 2 is a flowchart of an embodiment of a firmware updating method, in which the firmware is a flash ROM.

Detection programs are sent to the optical storage device (step S20) and analyze firmware thereon. Specifically, the detection programs issue instructions to the firmware. The firmware receives the instructions and responds accordingly to provide storage related information (step S22). Update programs corresponding to the firmware are sent to the optical storage device based on the storage related information (step S24). The storage related information can be type or version information of the firmware. Original firmware programs are then sent to the optical storage device (step S26). The optical storage device updates the original firmware programs using the update programs (step S28).

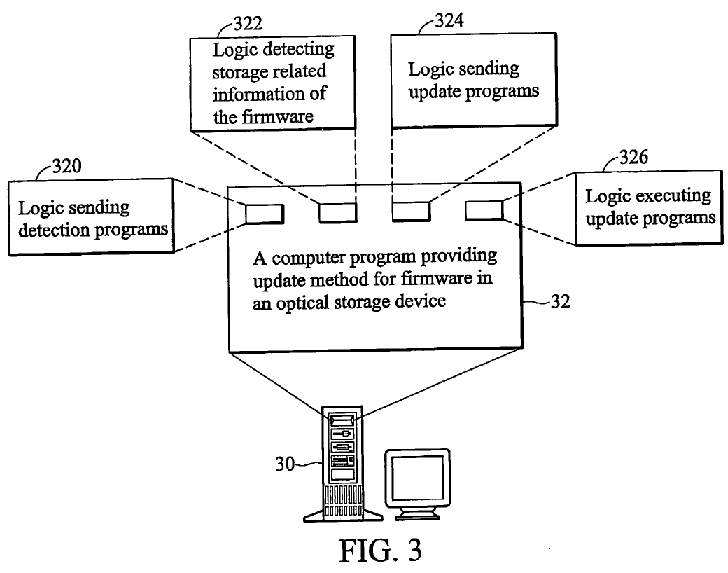

The method can be implemented in computer programs. FIG. 3 is a diagram of an embodiment of a machine-readable storage medium storing a computer program providing a firmware update method. As shown in FIG. 3, machine-readable storage medium 30 stores a computer program 32. The computer program 32 mainly comprises logic sending detection programs 320, logic detecting storage related information of the firmware 322, logic sending update programs 324, and logic executing update programs 326.

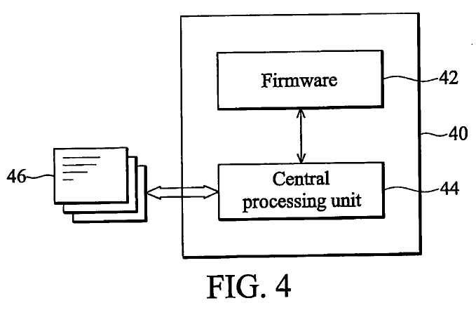

FIG. 4 is a diagram of an embodiment of an optical storage device 40, including firmware 42 and a central processing unit 44. Here, the firmware 42 is a flash ROM. The central processing unit 44 detects storage related information of the firmware and receives update programs 46 corresponding to the firmware 42 based on the detected storage related information. The central processing unit 44 then executes the update programs. Here, the storage related information may include type or version information of the firmware 42.

The central processing unit 44 further receives detection programs and analyzes the firmware 42 using the detection programs to acquire the storage related information. The central processing unit 44 further receives and updates original firmware programs using the update programs 46.

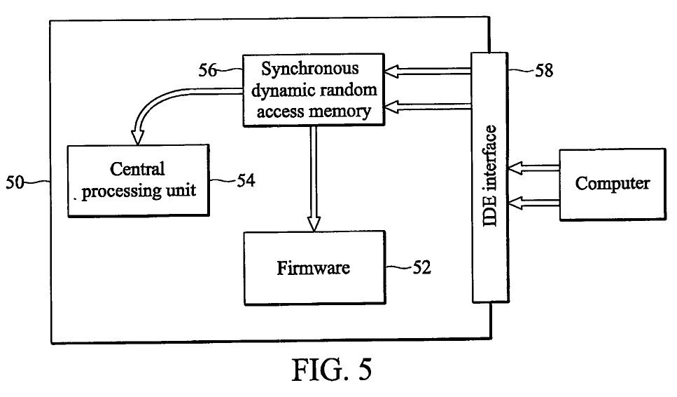

FIG. 5 is a diagram of an exemplary embodiment of an optical storage device 50 comprising firmware 52, implemented in a flash ROM, a central processing unit 54, and a synchronous dynamic random access memory (SDRAM) 56.

Detection programs are received through an integrated device electronics interface (IDE interface) 58. The central processing unit 54 analyzes the firmware 52 to acquire storage related information using the detection programs. Update programs corresponding to the firmware 52 are sent to the optical storage device 50 via the IDE interface 58. The update programs are first stored in the SDRAM 56. Thereafter, the central processing unit 54 can update original programs of the firmware 52 using the update programs.

Thus, embodiments of the present invention provide dynamic firmware update methods to detect firmware and send corresponding update programs. Firmware update problems can be resolved. Specifically, when the provided methods are employed to optical disk drives, modems or other devices with firmware, outstanding improvement are displayed.

Methods of the present invention, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An update method for firmware in an optical storage device, comprising:
detecting storage related information of the firmware in the optical storage device;
sending an update program corresponding to the firmware to the optical storage device according to the storage related information; and
executing the update program by the optical storage device.

2. The update method for firmware in an optical storage device as claimed in claim 1, wherein detection of the storage related information further comprises:
sending a detection program to the optical storage device; and
analyzing the firmware using the detection program to acquire the storage related information.

3. The update method for firmware in an optical storage device as claimed in claim 1, wherein execution of the update program further comprises:
sending an original firmware program to the optical storage device; and
the optical storage device updating the original firmware program using the update program.

4. The update method for firmware in an optical storage device as claimed in claim 1, wherein the firmware is a flash read-only-memory.

5. The update method for firmware in an optical storage device as claimed in claim 1, wherein the storage related information comprises the type of the firmware.

6. A machine-readable storage medium storing a computer program providing an update method for firmware in an optical storage device, the update method comprising:
detecting storage related information of the firmware in the optical storage device;
sending an update program corresponding to the firmware to the optical storage device according to the storage related information; and
executing the update program by the optical storage device.

7. The machine-readable storage medium as claimed in claim 6, wherein detection of the storage related information further comprises:
sending a detection program to the optical storage device; and
analyzing the firmware using the detection program to acquire the storage related information.

8. The machine-readable storage medium as claimed in claim 6, wherein execution of the update program further comprises:
sending an original firmware program to the optical storage device; and
the optical storage device updating the original firmware program using the update program.

9. The machine-readable storage medium as claimed in claim 6, wherein the firmware is a flash read-only-memory.

10. The machine-readable storage medium as claimed in claim 6, wherein the storage related information comprises the type of the firmware.

11. An optical storage device, comprising:
a firmware; and
a central processing unit, coupled to the firmware, detecting storage related information of the firmware, receiving an update program corresponding to the firmware according to the storage related information, and executing the update program.

12. The optical storage device as claimed in claim 11, wherein the central processing unit further receives a detection program and analyzes the firmware using the detection program to acquire the storage related information.

13. The optical storage device as claimed in claim 11, wherein the central processing unit further receives an original firmware program and updating the original firmware program using the update program.

14. The optical storage device as claimed in claim 11, wherein the firmware is a flash read-only-memory.

15. The optical storage device as claimed in claim 11, wherein the storage related information comprises the type of the firmware.
